(19) United States
(12) Patent Application Publication
(10) Pub. No.: US 2026/0217164 A1
(43) Pub. Date: Jul. 30, 2026

(54) TETHER ASSEMBLY AND SAFETY SEAT

(71) Applicant: Wonderland Switzerland AG, Steinhausen (CH)

(72) Inventor: Xiaohong XIAO, Guangdong (CN)

(73) Assignee: Wonderland Switzerland AG, Steinhausen (CH)

(21) Appl. No.: 19/457,967

(22) Filed: Jan. 23, 2026

(30) Foreign Application Priority Data
Jan. 24, 2025 (CN) 2025101214491

(51) Int. Cl. B60N 2/28

(52) U.S. Cl. CPC B60N 2/2809; B60N 2/2821

(57) ABSTRACT

A tether assembly for connecting a base of a safety seat to a vehicle includes a first connecting rod, a second connecting rod, and a tether. The first connecting rod is at least partially disposed above a top of the base, and the second connecting rod is disposed inside the base. The tether is connected to the second connecting rod and a part of the first connecting rod located above the top of the base, and is detachably connected to the vehicle.

### CROSS REFERENCE TO RELATED APPLICATIONS

The present disclosure claims priority to Chinese Application No. 202510121449.1 filed on January 24, 2025, which is incorporated herein by reference in its entirety.

### TECHNICAL FIELD

The present disclosure relates to the technical field of safety seats and, more particularly, to a tether assembly and a safety seat including the tether assembly.

### BACKGROUND

A safety seat is a seat installed on a vehicle seat for seating. Typically, the safety seat is designed specifically for children, with a restraining and protective function to enhance safety of children while riding in a vehicle.

To ensure more secure installation of the safety seat on the vehicle seat, the safety seat incorporates an additional top tether, with one end of the top tether being connected to the safety seat while the other end thereof being connected to the vehicle, to provide an extra anchor point for the installation of the safety seat and enhance the installation stability. However, the existing top tether is connected to the safety seat at a low position, or the top tether is led out at a low position from the safety seat, which may lead to an unstable connection between the safety seat and the vehicle, and pose a risk of tipping over.

### SUMMARY OF THE INVENTION

The present disclosure aims to provide a tether assembly, and a safety seat including the tether assembly. A connection height of the tether assembly is elevated, to stabilize connection of the safety seat and make the safety seat less prone to tipping over and safer to use.

According to one aspect of the present disclosure, a tether assembly is configured to connect a base or a seat body of a safety seat to a vehicle, and the tether assembly includes a first connecting rod, a second connecting rod, and a tether. The first connecting rod is at least partially disposed above a top of the base, and the second connecting rod is disposed inside the base. Alternatively, the first connecting rod is at least partially disposed above a top of the seat body, and the second connecting rod is disposed inside the seat body. The tether is connected to the second connecting rod and a part of the first connecting rod located above the top of the base or above the top of the seat body, and is detachably connected to the vehicle.

According to some embodiments of the present disclosure, the tether includes a connecting strap connected to the first connecting rod and the second connecting rod; the connecting strap forms a first loop and a second loop by winding at connection positions with the first connecting rod and the second connecting rod, respectively; the first connecting rod passes through the first loop and the second connecting rod passes through the second loop.

According to some embodiments of the present disclosure, the first connecting rod is connected to the second connecting rod.

According to some embodiments of the present disclosure, the tether assembly further includes a positioning rod that is disposed inside the base or the seat body together with the second connecting rod. The first connecting rod and the positioning rod are interconnected along a first direction, and the second connecting rod is connected, along a second direction intersecting with the first direction, to the first connecting rod and the positioning rod that are interconnected.

According to some embodiments of the present disclosure, the base or the seat body is provided with an exit hole, to allow the tether to extend between the first loop located above the top of the base or above the top of the seat body and the second loop located inside the base or the seat body.

According to some embodiments of the present disclosure, the tether assembly further includes a guide rod that is disposed inside the base or the seat body together with the second connecting rod. The guide rod is in contact with a part of the connecting strap located between the first loop and the second loop, to guide a routing direction of the connecting strap between the first loop and the second loop.

According to some embodiments of the present disclosure, the guide rod is located on a front side of the exit hole, to guide the tether to extend rearwards from the front side of the guide rod to the exit hole.

According to some embodiments of the present disclosure, the guide rod is connected to the first connecting rod.

According to some embodiments of the present disclosure, the tether assembly further includes a positioning rod that is disposed inside the base or the seat body together with the guide rod. The first connecting rod and the positioning rod are interconnected along a first direction, and the guide rod is connected, along a second direction intersecting with the first direction, to the first connecting rod and the positioning rod that are interconnected.

According to some embodiments of the present disclosure, the tether further includes an adjuster and an adjusting strap, the adjusting strap is connected to the connecting strap through the adjuster and is detachably connected to the vehicle, and the adjuster is configured to lock or unlock a length of the adjusting strap between the adjuster and the vehicle. A part of the connecting strap located between the first loop and the second loop form a third loop by winding, and the third loop is fitted over the adjuster.

According to some embodiments of the present disclosure, a winding space is formed between the top of the base or the seat body and a part of the first connecting rod located above the top of the base or the seat body, and the part of the connecting strap located between the first loop and the second loop passes through the winding space and forms the third loop by winding.

According to some embodiments of the present disclosure, the connecting strap is provided with a connection part, and the connecting strap is closed by the connection part to form the first loop and the third loop; the first loop and the third loop are located on two opposite sides of the connection part, and a winding direction of the connecting strap at the first loop is opposite to a winding direction of the connecting strap at the third loop.

According to another aspect of the present disclosure, a safety seat includes a base, a seat body, and the tether assembly according to any one of the above embodiments. The seat body is rotatably connected to the base and has a forward-facing use state and a rearward-facing use state relative to the base, and the tether assembly is configured to be disposed between the base and the vehicle.

According to some embodiments of the present disclosure, the base is provided with a first limiting hook, and the seat body is provided with a second limiting hook; the first limiting hook hooks with the second limiting hook when the seat body is in the forward-facing use state relative to the base; the first limiting hook separates from the second limiting hook when the seat body is in the rearward-facing use state relative to the base.

According to yet another aspect of the present disclosure, a method for assembling the tether assembly according to any one of the above embodiments to the base or the seat body includes: forming a first loop and a second loop by winding a connecting strap of the tether; making the first connecting rod pass through the first loop and mounting the first connecting rod to a rear cover of the base or the seat body; and allowing the second loop of the connecting strap to extend from a rear side of the rear cover to a front side of the rear cover through an exit hole of the rear cover.

According to some embodiments of the present disclosure, the method further includes: inserting the first connecting rod along a first direction into a positioning rod of the tether assembly, in which the positioning rod is fixed to a base body of the base or to a main body of a backrest of the seat body; inserting the second connecting rod, along a second direction intersecting with the first direction, into the first connecting rod and the positioning rod that are connected by insertion, and making the second connecting rod pass through the second loop.

According to some embodiments of the present disclosure, the method further includes: mounting a fixing member to the second connecting rod located on an outer side of the first connecting rod and the positioning rod that are connected by insertion.

According to some embodiments of the present disclosure, the method further includes: fastening the rear cover to the base body or to the main body of the backrest.

It should be understood that the above general description and the following detailed description are only exemplary and explanatory and are not intended to limit the present disclosure.

### BRIEF DESCRIPTION OF THE DRAWINGS

The accompanying drawings are included herein to provide further understanding of the present disclosure and are incorporated into this specification as a part thereof. The accompanying drawings illustrate embodiments of the present disclosure and are used together with the following description to illustrate concepts of the present disclosure.

FIG. 1 shows a perspective view and a partially enlarged view of a safety seat according to embodiments of the present disclosure, in which a seat body of the safety seat is in a forward-facing use state.

FIG. 2 shows a side view and a partially enlarged view of the safety seat according to embodiments of the present disclosure, in which the seat body of the safety seat is in the forward-facing use state.

FIG. 3 shows another perspective view of the safety seat according to embodiments of the present disclosure, in which the seat body of the safety seat is in a rearward-facing use state.

FIG. 4 shows a rear view of the safety seat shown in FIG. 1, with a tether hidden.

FIG. 5 shows a sectional view taken along A-A line in FIG. 4 and a partially enlarged view of the sectional view, schematically illustrating the way in which a connecting strap of the tether passes through.

FIG. 6 shows a rear perspective view and a partially enlarged view of the safety seat according to embodiments of the present disclosure, in which a rear cover of a base and the tether are hidden.

FIG. 7 shows a perspective view of a partial structure of a tether assembly and a partial structure of the base according to embodiments of the present disclosure.

FIG. 8 shows another perspective view of a partial structure of the tether assembly and a partial structure of the base according to embodiments of the present disclosure.

FIG. 9 shows a perspective view of a first connecting rod of the tether assembly and the rear cover of the base according to embodiments of the present disclosure.

FIG. 10 shows a front view of the first connecting rod and the rear cover shown in FIG. 9.

FIG. 11 shows a sectional view taken along B-B line in FIG. 10, schematically illustrating the way in which the connecting strap of the tether passes through.

FIG. 12 shows a partially exploded view and a partially enlarged view of a partial structure of the tether assembly and a base body of the base according to embodiments of the present disclosure, in which the tether is hidden.

FIG. 13 shows a side view of a partial structure of the tether assembly and the base body of the base according to embodiments of the present disclosure, in which the tether is hidden.

FIG. 14 shows a sectional view taken along C-C line in FIG. 13.

### DETAILED DESCRIPTION OF THE PREFERRED EMBODIMENTS

In order to further illustrate principles and structures of the present disclosure, some embodiments of the present disclosure will now be described in detail with reference to the accompanying drawings. However, it should be understood that the embodiments described are merely exemplary, and the present disclosure shall not be construed as being limited to the embodiments described herein.

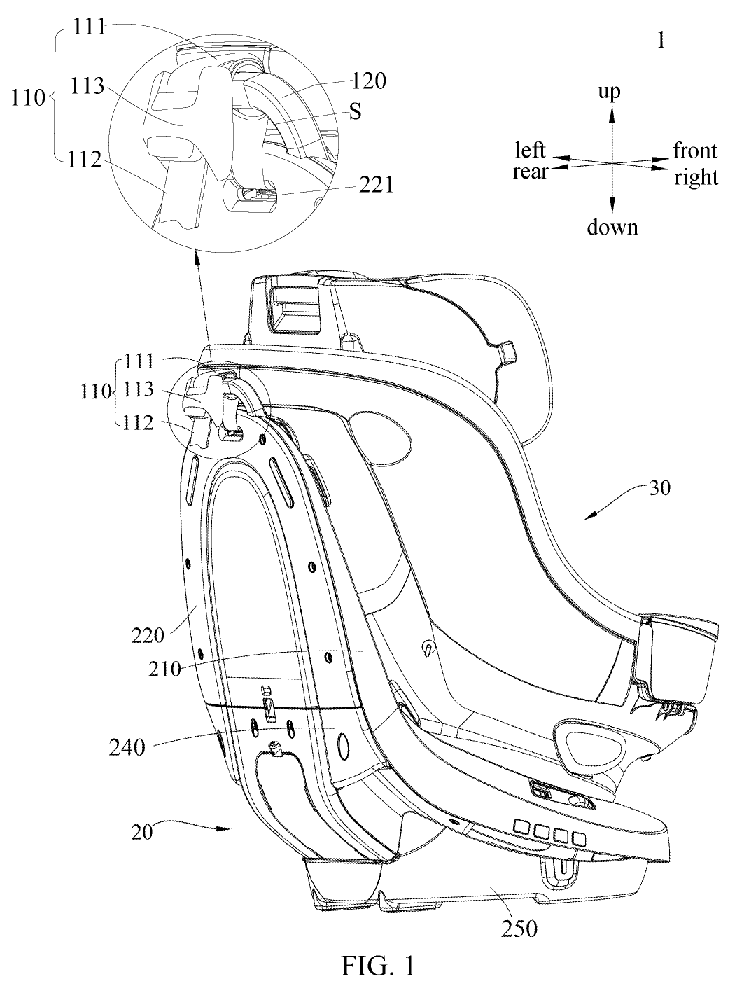

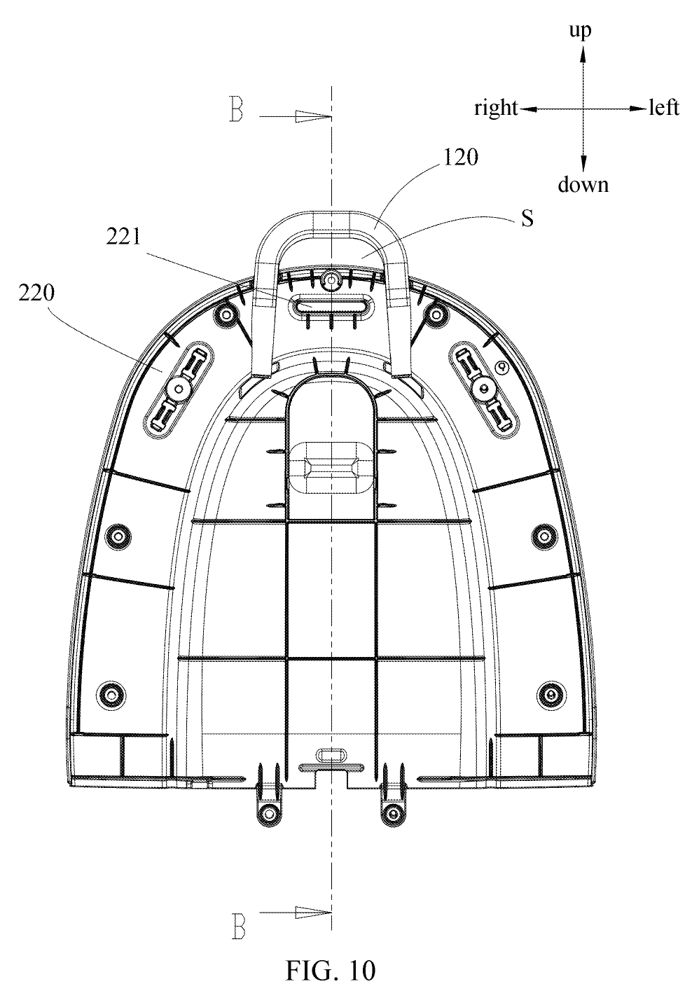

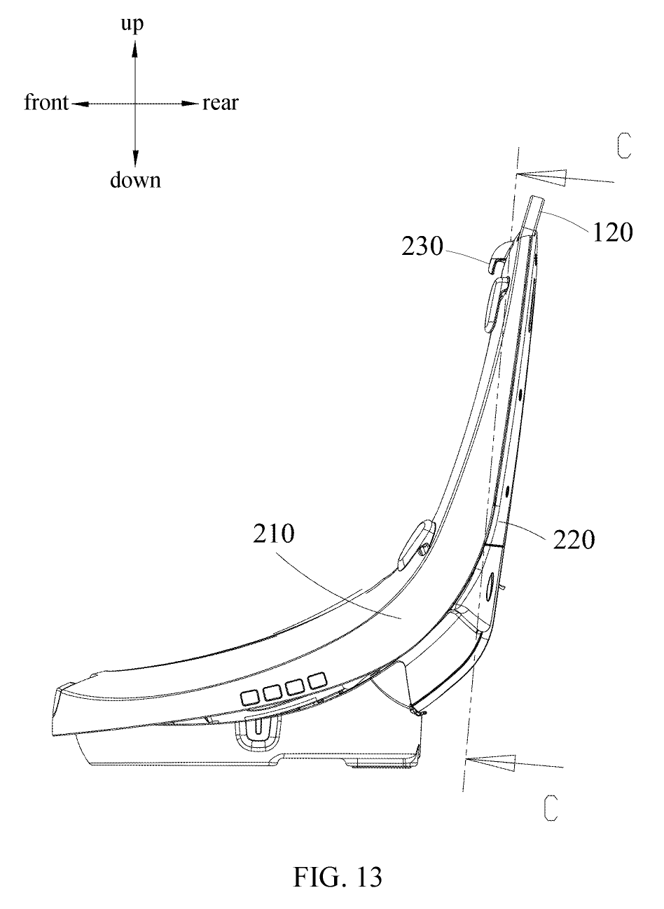

A safety seat according to the present disclosure may be applied to various types of passengers, including but not limited to children, pregnant women, adults with special body types, or pets. A child safety seat will be taken as an example below to describe the safety seat in detail with reference to FIGS. 1 to 14 and in conjunction with specific embodiments. In addition, for ease of understanding and description, reference to orientation terms such as front, rear, left, right, top and bottom is made based on orientations of the safety seat during normal use (for example, during normal use, a seat body of the safety seat is in a forward-facing use state, and a passenger sitting on the safety seat faces a front side of a vehicle, in which case a direction behind the passenger’s back is defined as the rear, and the left, right, top and bottom are determined accordingly). It should be understood that the present disclosure is not limited to these orientations, but may be adjusted according to actual situations.

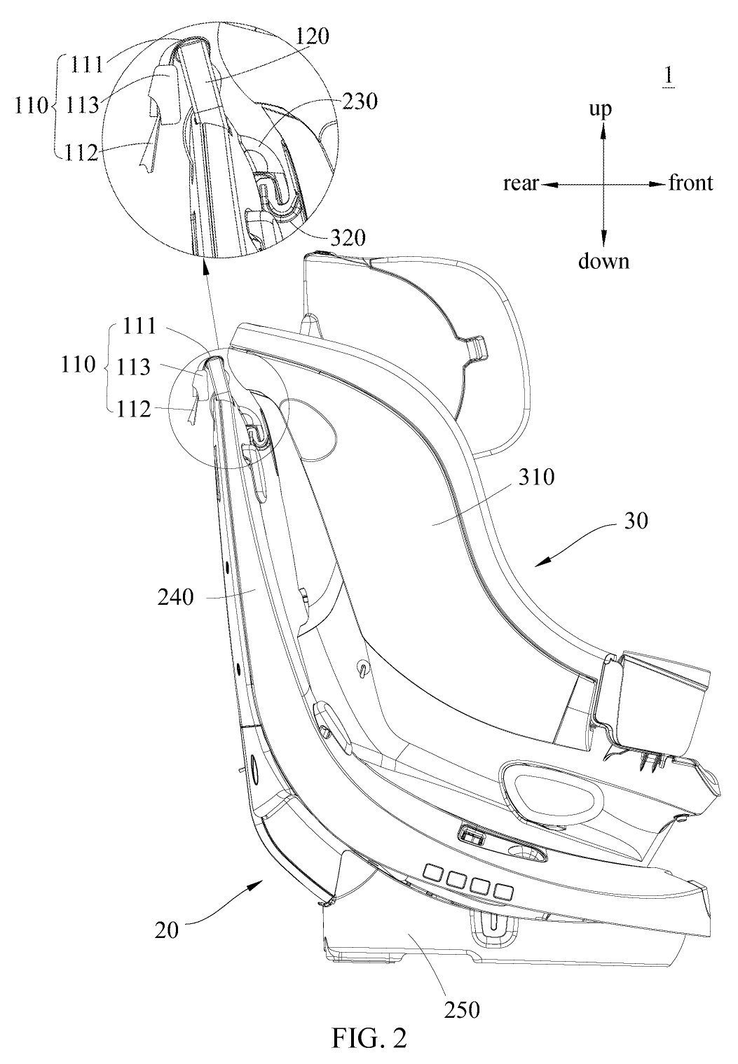

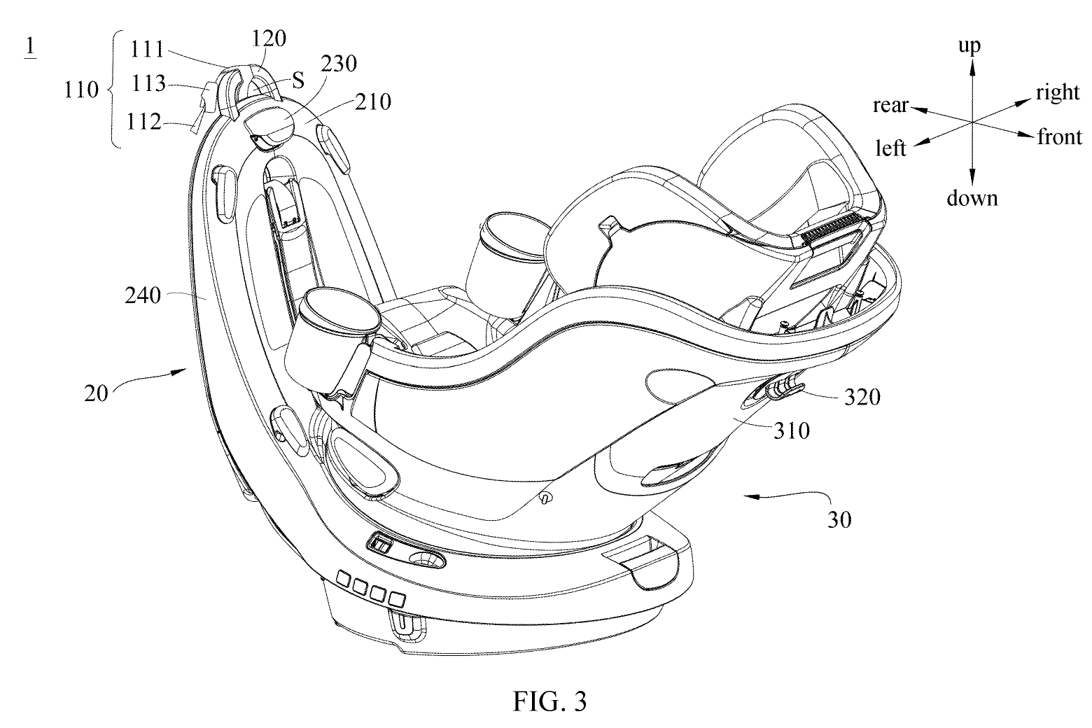

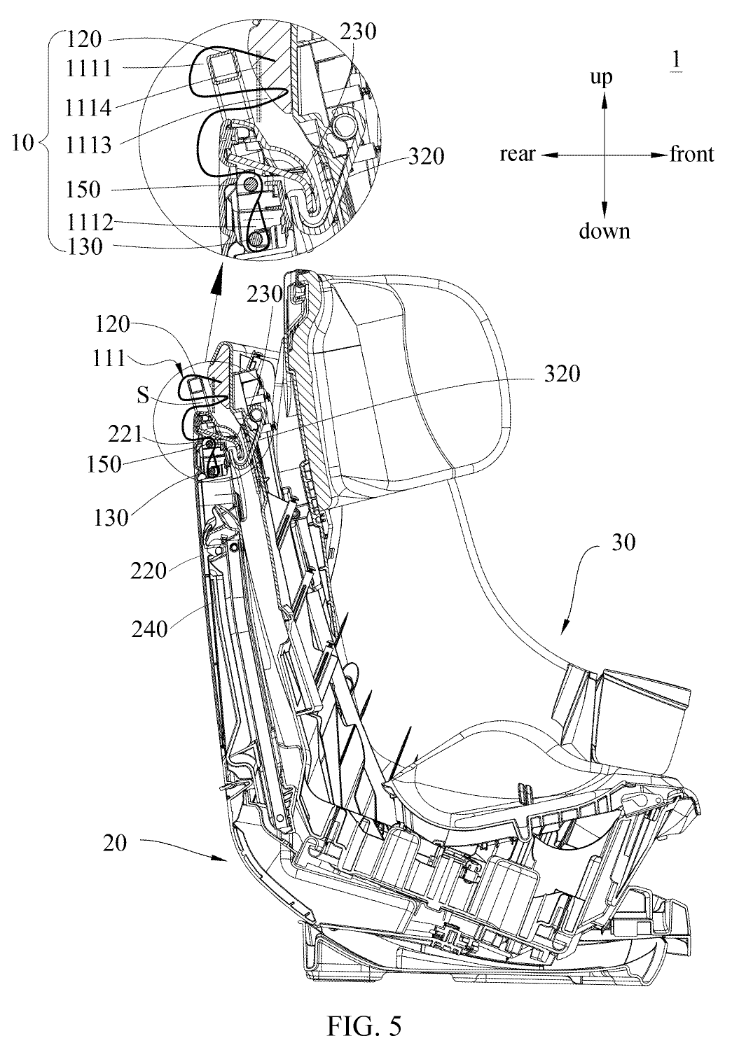

FIGS. 1 and 3 show perspective views of a safety seat 1 according to the present disclosure from different angles. The safety seat 1 may include a tether assembly 10 (as shown in FIG. 5), a base 20, and a seat body 30. The base 20 is substantially L-shaped and includes a vertical portion 240 and a horizontal portion 250. The seat body 30 is rotatably mounted on the base 20; for example, the seat body 30 may rotate by 180° relative to the base 20. Through rotation, the seat body 30 may be in a forward-facing use state (as shown in FIGS. 1 and 2) or in a rearward-facing use state (as shown in FIG. 3). Specifically, when in the forward-facing use state, a passenger sitting on the seat body 30 faces a front side of a vehicle (for a child safety seat, this use state is usually suitable for an elder child); when in the rearward-facing use state, the passenger sitting on the seat body 30 faces a rear side of the vehicle (for the child safety seat, this use state is usually suitable for an infant). As shown in FIGS. 1 to 3, the tether assembly 10 is mounted on the base 20 and configured to connect the base 20 to the vehicle, thereby connecting the seat body 30 to the vehicle (FIGS. 1 to 3 only shows a tether 110 and a first connecting rod 120 of the tether assembly 10, and rest parts of the tether assembly 10 are not shown in FIGS. 1 to 3 as they are inside the base 20).

In addition, referring to FIGS. 2, 3 and 5, the vertical portion 240 of the base 20 may be provided with a first limiting hook 230, and a backrest 310 of the seat body 30 may be provided with a second limiting hook 320. The first limiting hook 230 may be configured to hook with the second limiting hook 320. When the seat body 30 is in the forward-facing use state, the first limiting hook 230 may hook with the second limiting hook 320, allowing the seat body 30 to be more firmly connected to the base 20, thereby improving the safety of the safety seat 1. When the seat body 30 rotates to the rearward-facing use state, the first limiting hook 230 may separate from and disengage from the second limiting hook 320.

In addition, the base 20 of the safety seat 1 may also be substantially in a straight shape and include only the horizontal portion 250; in such a case, the seat body 30 may adjust its tilt angle relative to the base 20, but cannot rotate to the above-mentioned rearward-facing use state. Alternatively, the safety seat 1 may not include the base 20, and the seat body 30 may be positioned only in the forward-facing use state; such safety seats are usually designed for elder children or children with larger body sizes. In both of the aforementioned cases, the tether assembly 10 may be directly mounted to the backrest 310 of the seat body 30 and configured to directly connect the seat body 30 to the vehicle.

As described above, the tether assembly 10 may be disposed on the base 20 or the seat body 30. The following description will take the case of the tether assembly 10 being disposed on the base 20 as an example.

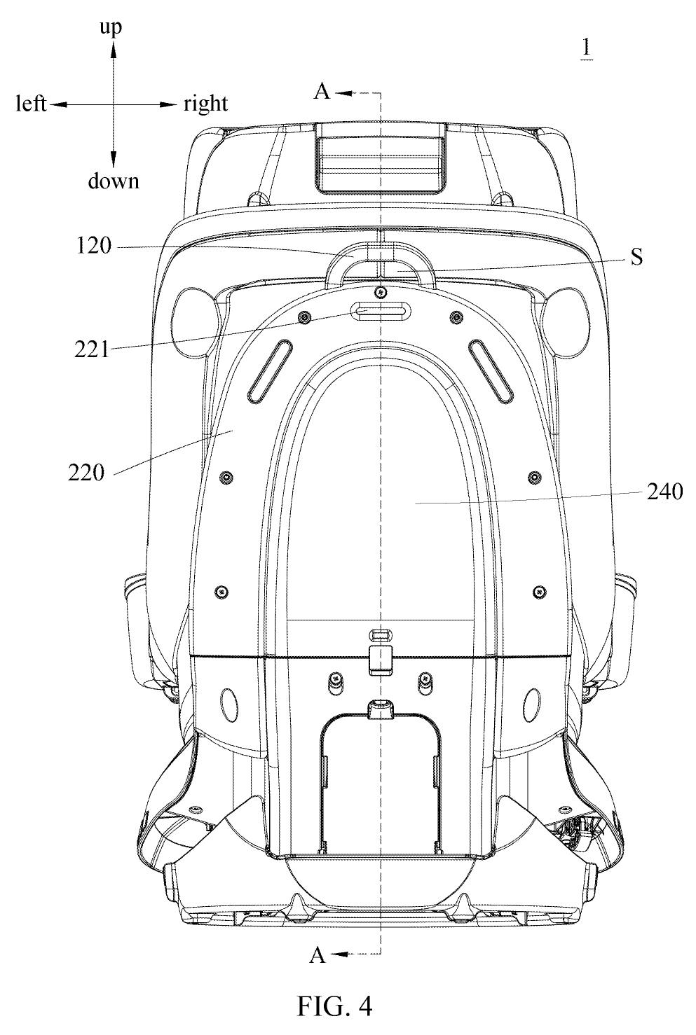

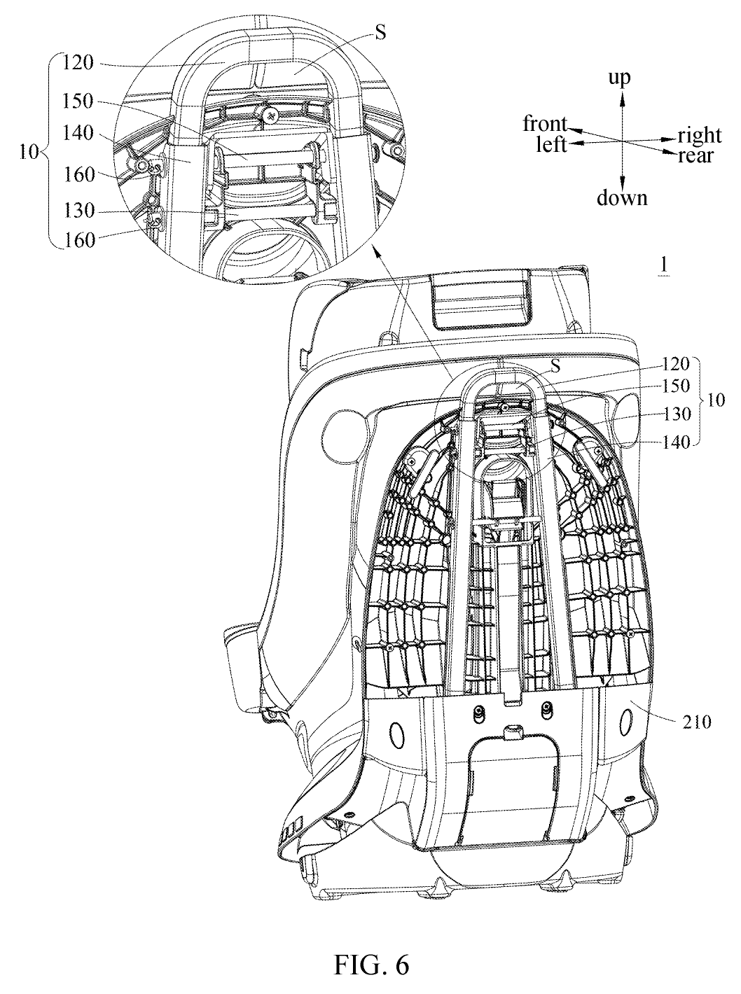

FIG. 5 shows the safety seat 1 according to the present disclosure in a sectional view and a partially enlarged view based on FIG. 4. FIG. 6 shows a structure of the tether assembly 10 inside the base 20 in a rear perspective view and a partially enlarged view. As shown in FIGS. 4 to 6, the tether assembly 10 is disposed on the base 20 (optionally the vertical portion 240), and includes the tether 110 (as shown in FIG. 3), the first connecting rod 120, and a second connecting rod 130. The tether 110 is indirectly connected to the base 20 through the first connecting rod 120 and the second connecting rod 130, and the tether 110 is detachably connected to the vehicle. Optionally, the first connecting rod 120 is at least partially disposed above a top of the base 20 (optionally the vertical portion 240); the second connecting rod 130 is disposed inside the base 20 (optionally the vertical portion 240); and the first connecting rod 120 and the second connecting rod 130 are immovable relative to the base 20. The tether 110 is connected to the first connecting rod 120 protruding from the top of the base 20 and is connected to the second connecting rod 130. That is, the tether 110 may be indirectly connected to the base 20 at two different positions, and one of the connection positions is located above the top of the base 20. Optionally, the tether 110 may include a connecting strap 111, and the connecting strap 111 is connected to the first connecting rod 120 protruding from the top of the base 20 and connected to the second connecting rod 130. Due to the connection between the connecting strap 111 and the first connecting rod 120 protruding from the top of the base 20, a height of the connection position between the tether 110 (optionally the connecting strap 111) and the base 20 is elevated, so that the tether 110 (optionally the connecting strap 111) may be connected to the vehicle at a higher position, thereby making the connection between the safety seat 1 and the vehicle more stable, reducing a risk of tipping over, and enhancing safety. In addition, since the tether 110 (optionally the connecting strap 111) is connected to the first connecting rod 120 and the second connecting rod 130 at two different positions along an up-down direction, the connection between the tether 110 (optionally the connecting strap 111) and the base 20 is more stable and reliable.

In an embodiment shown in FIG. 5, the connecting strap 111 may form a first loop 1111 and a second loop 1112 by winding at the connection positions with the first connecting rod 120 and the second connecting rod 130. That is, the first connecting rod 120 passes through the first loop 1111, and the second connecting rod 130 passes through the second loop 1112. Optionally, the first loop 1111 and the second loop 1112 may be closed loops formed by stitching (e.g., a sewing process) the connecting strap 111. However, the present disclosure is not limited thereto and other fixing means may also be adopted to form closed loops.

Since the connecting strap 111 is fitted over the first connecting rod 120 and the second connecting rod 130 in the form of closed loops, an adjustable relative displacement between the connecting strap 111 and the first connecting rod 120 or the second connecting rod 130 is relatively small. Compared with simply winding around the first connecting rod 120 or the second connecting rod 130 (where the adjustable relative displacement between the connecting strap 111 and the first connecting rod 120 or the second connecting rod 130 is relatively large), the stability of the connection between the connecting strap 111 and the base 20 may be enhanced, the movement of the base 20 may be better restricted, and hence the movement of the seat body 30 may be restricted, thereby reducing a risk that the entire safety seat 1 rushes forwards when the vehicle brakes suddenly or collides.

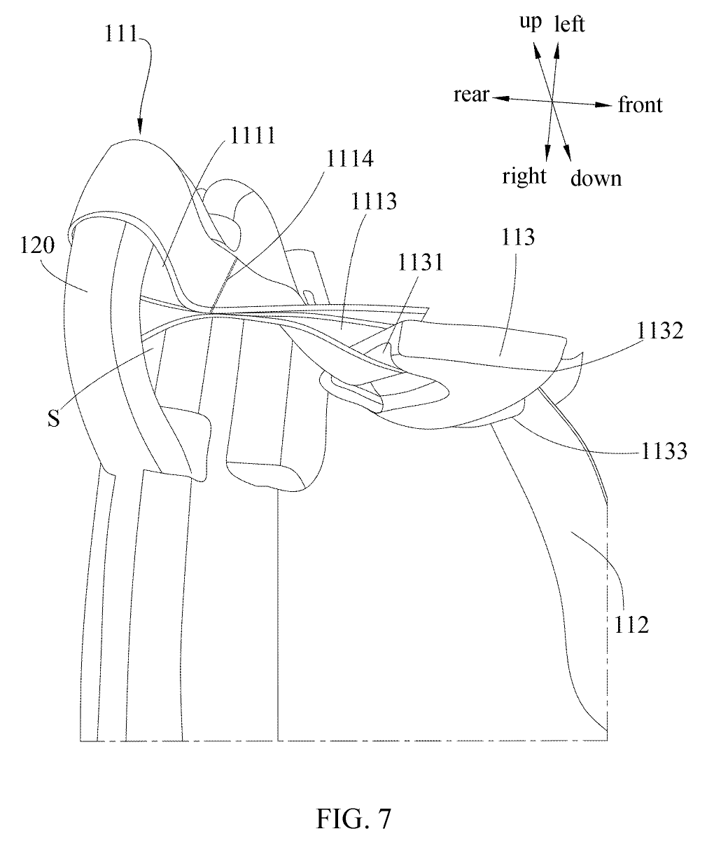

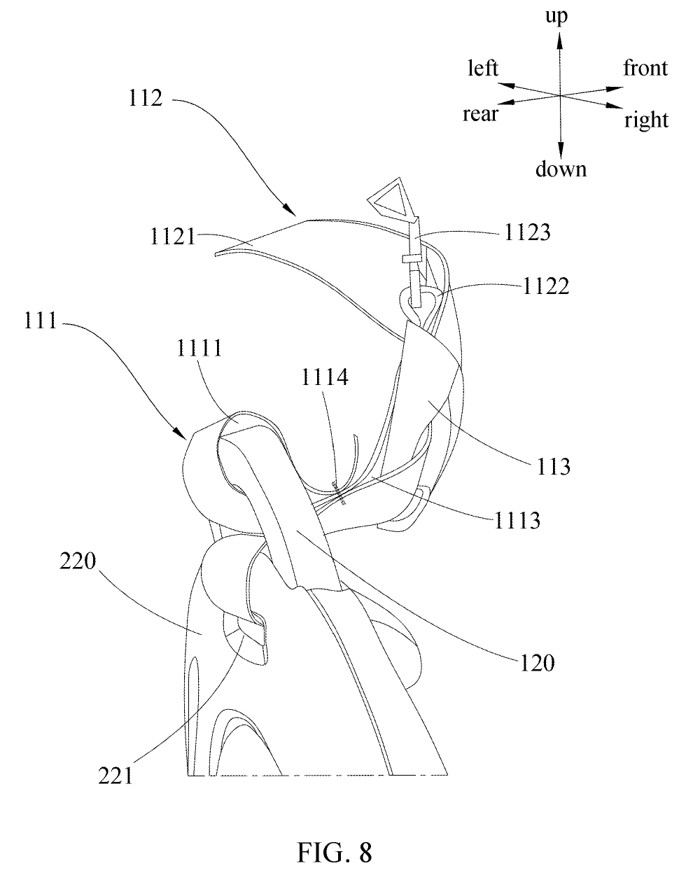

FIGS. 7 and 8 show a partial structure of the tether assembly 10 and a partial structure of the base 20 in perspective views. As described above, the connecting strap 111 is fitted over the first connecting rod 120 through the first loop 1111, so a length of a part of the connecting strap 111 that is fitted over the first connecting rod 120 remains unchanged. Moreover, the connecting strap 111 is fitted over the second connecting rod 130 through the second loop 1112, so a length of a part of the connecting strap 111 that is fitted over the second connecting rod 130 remains unchanged. There is almost no relative displacement between the first connecting rod 120 and the first loop 1111, and no relative displacement between the second connecting rod 130 and the second loop 1112, when the tether 110 is connected to the vehicle. Although there is a gap between the first connecting rod 120 and the first loop 1111, and a gap between the second connecting rod 130 and the second loop 1112, the gaps are merely to facilitate passage of the first connecting rod 120 through the first loop 1111 and passage of the second connecting rod 130 through the second loop 1112 during installation. These gaps may be designed as small as possible.

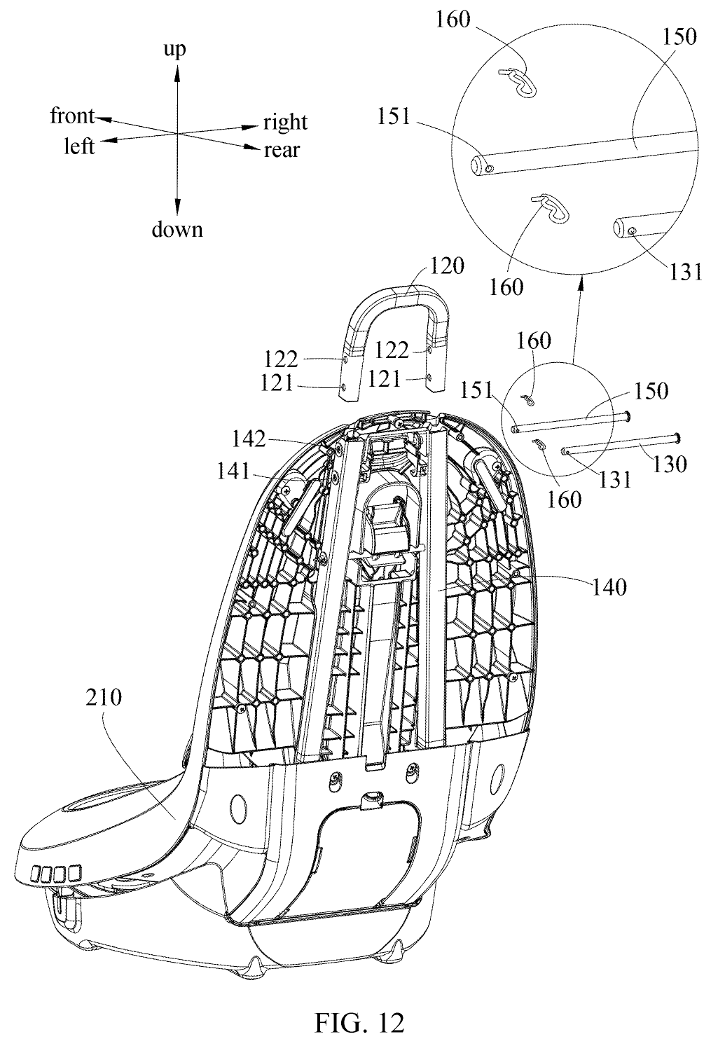

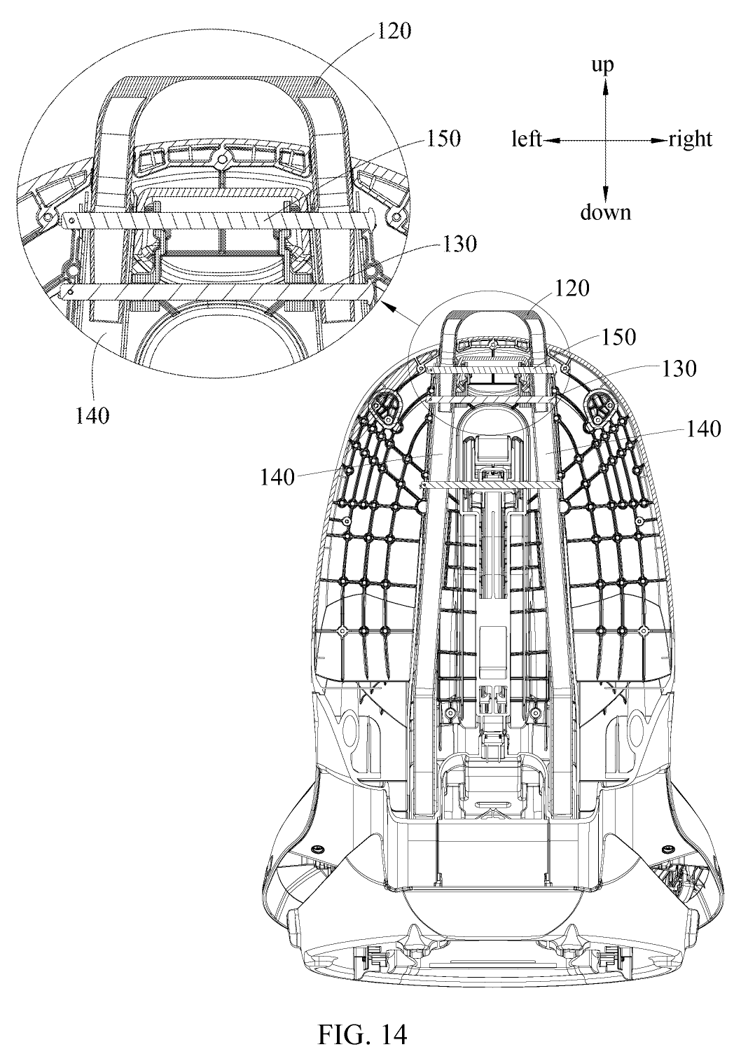

As shown in FIGS. 5 and 6, the tether assembly 10 may further include a positioning rod 140, which may be disposed inside the base 20 and fixedly connected to the base 20. Optionally, the first connecting rod 120 and the second connecting rod 130 may be each connected to the positioning rod 140, thereby being indirectly connected to the base 20. Optionally, the first connecting rod 120 is also connected to the second connecting rod 130. Optionally, the first connecting rod 120 may be fixedly connected to the positioning rod 140 through the second connecting rod 130, and then indirectly connected to the base 20 through the positioning rod 140. Optionally, referring to FIGS. 12 and 14, the number of positioning rods 140 may be two, and two positioning rods 140 may each extend along the vertical portion 240 of the L-shaped base 20. The first connecting rod 120 may be constructed in an inverted U-shape, with its two ends inserted downward into ends of the two positioning rods 140 in the up-down direction (also called a first direction). In addition, each of the two ends of the first connecting rod 120 in the inverted U-shape may have a first hole 121; each positioning rod 140 may have a first connecting hole 141 corresponding to the first hole 121, and the first connecting hole 141 is specifically located at an end of each positioning rod 140 where one end of the inverted U-shaped first connecting rod 120 is inserted; the second connecting rod 130 may pass through the first connecting holes 141 and the first holes 121 in a left-right direction (also called a second direction) to connect the two positioning rods 140 and the first connecting rod 120. Optionally, the second connecting rod 130 extending in the left-right direction may, for example, pass with its left end from right to left through the first hole 121 at a right end of the inverted U-shaped first connecting rod 120 and the first connecting hole 141 at an end of one positioning rod 140 on a right side, then continue moving leftwards to pass through the second loop 1112 of the connecting belt 111, and simultaneously pass through the first hole 121 at a left end of the inverted U-shaped first connecting rod 120 and the first connecting hole 141 at an end of the other positioning rod 140 on a left side. Finally, the left end of the second connecting rod 130 exits from the first connecting hole 141 at the end of the other positioning rod 140 on the left side. It is evident that the second loop 1112 is located between two positioning rods 140. Therefore, the second connecting rod 130 may not only be used for connection with the connecting strap 111, but also for connection between the positioning rod 140 with the first connecting rod 120. Such a multifunctional design improves the structural compactness of the tether assembly 10. Optionally, the first direction and the second direction may not necessarily be the up-down direction and the left-right direction, as long as they intersect with each other.

Certainly, it can be understood that only a single U-shaped positioning rod 140 may be provided inside the base 20, and both ends of the U-shaped positioning rod 140 may be configured for insertion of the two ends of the inverted U-shaped first connecting rod 120. The shape and quantity of the positioning rod 140 will not be specifically limited in the present disclosure.

Optionally, the first connecting rod 120 and the second connecting rod 130 may be directly fixedly connected to the base 20 after passing through the first loop 1111 and the second loop 1112, without any connection between the first connecting rod 120 and the second connecting rod 130.

Since the connecting strap 111 is fitted over the first connecting rod 120 (specifically a part of the first connecting rod 120 protruding from the top of the base 20) and the second connecting rod 130 by the first loop 1111 and the second loop 1112, respectively, the base 20 is provided with an exit hole 221 to allow the connecting strap 111 to extend between an exterior and an interior of the base 20. Optionally, as shown in FIGS. 1, 4, and 5, the base 20 is provided with the exit hole 221, to allow the connecting strap 111 to extend between the first loop 1111 located outside the base 20 and the second loop 1112 located inside the base 20. Moreover, the exit hole 221 is located between the first loop 1111 and the second loop 1112.

In addition, as shown in FIGS. 5 and 6, the tether assembly 10 may further include a guide rod 150, which may be disposed inside the base 20 and configured to guide the extension of the connecting strap 114. Optionally, the guide rod 150 contacts a part of the connecting strap 111 located between the first loop 1111 and the second loop 1112 to guide routing of the connecting strap 111 between the first loop 1111 and the second loop 1112. The guide rod 150 is connected to the positioning rod 140, and in turn indirectly connected to the base 20. The guide rod 150 is also connected to the first connecting rod 120. Optionally, the first connecting rod 120 may be fixedly connected to two positioning rods 140 through the guide rod 150. Optionally, referring to FIGS. 12 and 14, each of the two ends of the inverted U-shaped first connecting rod 120 may further have a second hole 122 located above the corresponding first hole 121, and each positioning rod 140 may further be provided with a second connecting hole 142 corresponding to the second hole 122. Specifically, the second connecting hole 142 is also located at the end of each positioning rod 140 where one end of the inverted U-shaped first connecting rod 120 is inserted, and is located above the corresponding first connecting hole 141. Thus, the guide rod 150 may simultaneously pass through the second connecting holes 142 and the second holes 122 along the left-right direction (also called the second direction) to connect the two positioning rods 140 with the first connecting rod 120. Optionally, the guide rod 150 extending in the left-right direction may, for example, pass with its left end from right to left through the second hole 122 at the right end of the inverted U-shaped first connecting rod 120 and the second connecting hole 142 at the end of one positioning rod 140 on the right side, then continue moving leftwards and contact the connecting strap 111 to guide the extension of the connecting strap 111, and then pass through the second hole 122 at the left end of the inverted U-shaped first connecting rod 120 and the second connecting hole 142 at the end of the other positioning rod 140 on the left side. Finally, the left end of the guide rod 150 exits from the second connecting hole 142 at the end of the other positioning rod 140 on the left side. Since the second hole 122 is located above the first hole 121 and the second connecting hole 142 is located above the first connecting hole 141, it can be determined that the guide rod 150 is located above the second connecting rod 130. Moreover, the guide rod 150 may be disposed parallel to the second connecting rod 130. Optionally, an extension direction of the guide rod 150 may also intersect with an extension direction of the second connecting rod 130. The guide rod 150 is also multifunctional, which may be used to connect the positioning rod 140 with the first connecting rod 120 and to guide a routing direction of the connecting strap 111 inside the base 20, further improving the structural compactness of the tether assembly 10.

Optionally, the guide rod 150 may be directly fixedly connected to the base 20, and does not need to be indirectly connected to the base 20 through the positioning rods 140.

Optionally, the first connecting rod 120 may be fixedly connected to the two positioning rods 140 only through the guide rod 150, and the second connecting rod 130 only passes through the positioning rods 140 in the left-right direction without passing through the first connecting rod 120 in the left-right direction. Optionally, the first connecting rod 120 may be fixedly connected to the two positioning rods 140 only through the second connecting rod 130, and the guide rod 150 only passes through the positioning rods 140 in the left-right direction without passing through the first connecting rod 120 in the left-right direction.

As shown in FIG. 5, a partial surface of the guide rod 150 is flush with the above-mentioned exit hole 221, allowing the connecting strap 111 to smoothly extend to the exit hole 221 under guidance of the guide rod 150 and then to the exterior of the base 20. Optionally, the exit hole 221 is located on a rear side of the guide rod 150, and the connecting strap 111 comes from a front side of the guide rod 150, that is, the guide rod 150 contacts a rear side of the connecting strap 111 and guides the connecting strap 111 towards the exit hole 221 on the rear side to the exterior of the base 20. Optionally, the base 20 includes a base body 210 and a rear cover 220 that are connected to each other in a front-rear direction; the rear cover 220 is located on a rear side of the base body 210; the positioning rod 140 is fixedly disposed on the base body 210 (specifically on the rear side of the base body 210); and the exit hole 221 is disposed on the rear cover 220 of the base 20. Inside the base 20, the connecting strap 111 may be fitted over the second connecting rod 130 through the second loop 1112, extend upwards from the second loop 1112 and forwards to the front side of the guide rod 150, and then extend upwards and rearwards from the front side of the guide rod 150. Finally, the connecting strap 111 extends through the exit hole 221 to the exterior of the base 20 (i.e., behind the rear cover 220), and then extends upwards to the first loop 1111 that is fitted over the first connecting rod 120. Optionally, the exit hole 221 may be positioned higher than the guide rod 150 to ensure that the connecting strap 111 overall extends upwards from the second loop 1112 onwards.

It should be noted that in terms of the structure of the base 20, the base 20 includes the base body 210 and the rear cover 220, and in terms of the shape of the base 20, the base 20 may be considered as including the vertical portion 240 and the horizontal portion 250.

As shown in FIGS. 1 to 3 and 7 to 8, the tether 110 may further include an adjusting strap 112 and an adjuster 113. The adjusting strap 112 is connected to the connecting strap 111 through the adjuster 113 and is configured for detachable connection with the vehicle. The adjusting strap 112 is connected between the adjuster 113 and the vehicle, and the adjuster 113 is configured to lock or unlock a length of the adjusting strap 112 between the adjuster 113 and the vehicle. Optionally, the connecting strap 111 is connected to the base 20 and the adjuster 113 and has a fixed length between the base 20 and the adjuster 113 is fixed; the adjusting strap 112 passes through the adjuster 113 and has an adjustable length between the adjuster 113 and the vehicle, so that a working length of the tether 110 between the base 20 and the vehicle may be adjusted. The connecting strap 111 and the adjusting strap 112 may be respectively connected to two opposite ends of the adjuster 113 (hereinafter referred to as a fixed end 1131 and an operating end 1132).

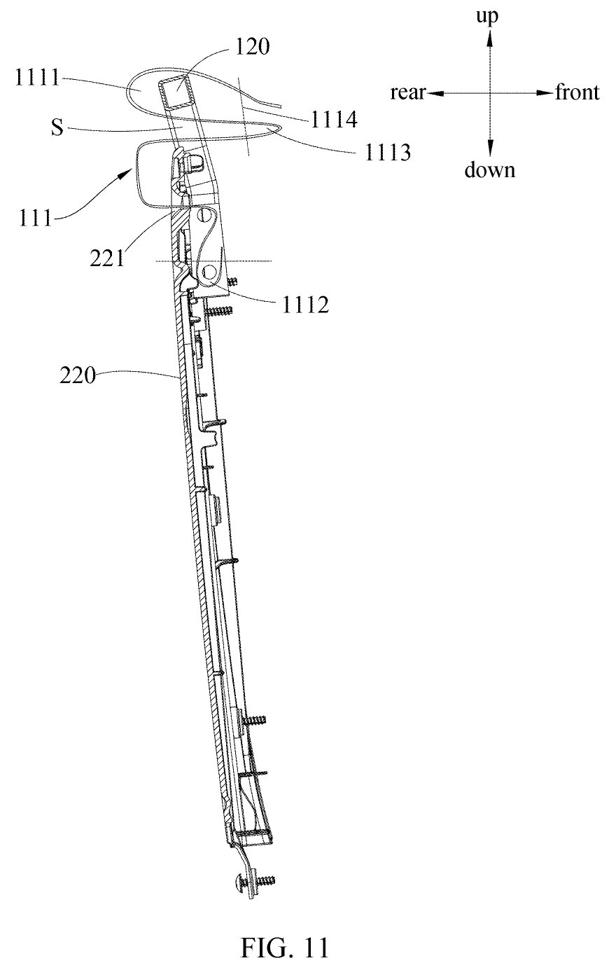

As shown in FIGS. 8 and 11, in order to connect the connecting strap 111 with the adjuster 113, a part of the connecting strap 111 between the first loop 1111 and the second loop 1112 forms a third loop 1113 by winding, and the third loop 1113 is fitted over the adjuster 113. Specifically, the fixed end 131 of the adjuster 113 may be provided with an opening, through which the connecting strap 111 may pass; and the connecting strap 111 passes through the opening of the fixed end 131 of the adjuster 113 and is sewn to form the third loop 1113. The adjuster 113 may be provided with a rod member at the fixed end 1131 of the adjuster 113, the rod member is located on a side of the opening, and the third loop 1113 is fitted over the rod member.

As described above, at least a part of the first connecting rod 120 is disposed above the top of the base 20, so that the part of the first connecting rod 120 located above the top of the base 20 together with the top of the base 20 encloses a winding space S. Optionally, as shown in FIGS. 1 and 3 to 6, the inverted U-shaped first connecting rod 120 includes two vertical segments that are spaced apart and oppositely arranged and an intermediate segment connected between the two vertical segments. After the two ends of the inverted U-shaped first connecting rod 120 are inserted into the two positioning rods 140, parts of the two vertical segments on both sides of the inverted U-shape and the intermediate segment of the inverted U-shape may protrude from the top of the base 20, forming the winding space S among the top of the base 20, and the parts of the two vertical segments and the intermediate segment that protrude from the top of the base 20.

As shown in FIG. 5, the connecting strap 111 passes through the winding space S and forms the third loop by winding. Optionally, a routing path of the connecting strap 111 extending from the exit hole 221 in the rear cover 220 may be understood as follows: the connecting strap 111 enters the winding space S from rear to front, continues extending forwards by a certain distance to exceed the first connecting rod 120, then bends rearwards to return to the winding space S from front to rear (or turns back from front to rear), thus forming two overlapping segments, and winds upwards and forwards to a front side of the first connecting rod 120, so that the connecting strap 111 reaches the front side of the first connecting rod 120 (or winding space S), thus forming three overlapping segments. In front of the first connecting rod 120, the three overlapping segments are connected together (e.g., by stitching) to form a connection part 1114 (e.g., stitches), and the first loop 1111 and the third loop 1113 are formed on both sides of the connection part 114. It can be known that the third loop 1113 is located in front of the first connecting rod 120, and winding directions of the first loop 1111 and the third loop 1113 are opposite, in which the connecting strap 111 is wound from rear to front to form the first loop 1111 and is wound from front to rear to form the third loop 1113. Moreover, the connection part 1114 is located on the front side of the first connecting rod 120, while the exit hole 221 is located on a rear side of the first connecting rod 120. It can be known that the connection part 1114 and the exit hole 221 are on two opposite sides of the first connecting rod 120.

Optionally, the third loop 1113 may be located on the rear side of the first connecting rod 120; the connecting strap 111 only passes through the winding space S when forming the first loop 1111; the connecting strap 111 is sewn at different positions to form the first loop 1111 and the third loop 1113, and the winding directions of the first loop 1111 and the third loop 1113 are identical.

As shown in FIGS. 7 and 8, the adjusting strap 112 may include an adjusting end 1121 and a connecting end 1122, and the adjusting strap 112 passes through the operating end 1132 of the adjuster 113. Optionally, the operating end 1132 may be provided with an opening, through which the adjusting end 1121 may pass, so as to connect the adjusting strap 112 to the operating end 1132. The connecting end 1122 is connected to a corresponding connection part of the vehicle, and the adjuster 113 is configured to adjust a length of the adjusting strap 112 between the connecting end 1122 and the operating end 1132. In this way, the tether assembly 10 may be applied to different models of vehicles to ensure an optimal fixing effect and safety between the safety seat and the vehicle. Optionally, the adjusting strap 112 may be provided with a connector 1123 (such as a hook) at the connecting end 1122 for detachable connection to a top tether interface of the vehicle.

As shown in FIG. 7, in addition, the adjuster 113 may be provided with an adjusting knob 1133 (such as a pushbutton or a rotary knob) at the operating end 1132, and the adjusting knob 1133 has a locking state and an unlocking state. When the adjusting knob 1133 is in the locking state, the length of the adjusting strap 112 between the connecting end 1122 and the operating end 1132 cannot be adjusted. When the adjusting knob 1133 is in the unlocking state, the length of the adjusting strap 112 between the connecting end 1122 and the operating end 1132 is adjustable. A user may switch the adjusting knob 1133 from the locking state to the unlocking state by pressing or rotating it, which enables the connecting end 1122 of the adjusting strap 112 to be pulled in a direction away from the adjuster 113, increasing the length of the adjusting strap 112 between the connecting end 1122 and the operating end 1132, or enables the connecting end 1122 of the adjusting strap 112 to be retracted in a direction towards the adjuster 113, decreasing the length of the adjusting strap 112 between the connecting end 1122 and the operating end 1132.

It should be understood that the adjusting strap 112 and the adjuster 113 shown in FIG. 7 are located in the front of the base 20, but during installation or use of the tether assembly 10, the adjusting strap 112 and the adjuster 113 will be lifted to the rear of the base 20 (as shown in FIGS. 1 to 3). During movement of the adjusting strap 112 and the adjuster 113 from front to rear (as shown in FIG. 8), the adjusting strap 112 and the adjuster 113 pass over the first connecting rod 120, that is, besides the first loop 1111, another part (for example the third loop 1113) of the connecting belt 111 is also routed over the first connecting rod 120, so that the adjuster 113 and the adjusting strap 112 may reach the rear of the base 20, allowing the adjusting strap 112 to be connected with the vehicle, which may ensure a height of a leading-out position of the tether 110 (optionally the connecting strap 111), and further prevent the safety seat 1 from tipping over.

Optionally, the tether 110 may include only the connecting strap 111, which is directly connected to the corresponding connection part of the vehicle. In such a case, the tether 110 does not have a length-adjusting function.

A situation where the tether assembly 10 is disposed on the base 20 is schematically described above. In another situation where the base 20 is in the straight shape or there is no base 20, the tether assembly 10 may be directly disposed on the seat body 30, optionally the backrest 310 of the seat body 30. Similar to the situation of being disposed on the base 20, the first connecting rod 120 is at least partially disposed above a top of the seat body 30 (optionally the backrest 310) and encloses the winding space S together with the top of the seat body 30 (optionally the backrest 310). The positioning rod 140 is disposed inside the seat body 30 (optionally a rear side of a main body of the backrest 310). The second connecting rod 130 and the guide rod 150 are both located inside the seat body 30 (optionally the backrest 310) and are both connected to the positioning rod 140 and the first connecting rod 120. The seat body 30 (optionally a rear cover of the backrest 310) may be provided with the exit hole 221. The connection relationship between the tether 110 and the first connecting rod 120 and the second connecting rod 130, as well as the positional relationship between the positioning rod 140 and the first connecting rod 110, the second connecting rod 120, and the guide rod 150, is as described above and will not be repeated here.

A method of assembling the tether assembly 10 to the base will be described in detail below.

It can be understood that the connecting strap 111 may be stitched in advance (e.g., the sewing process) to form the first loop 1111 and the second loop 1112, and the first loop 1111 is located above the second loop 1112. Dashed lines in FIGS. 5, 7 to 8, and 11 represent stitching lines (e.g., stitching lines), and as shown in these figures, while forming the first loop 1111, the connecting strap 111 may also form the third loop 1113, which is adjacent to the first loop 1111. However, it should be understood that when the tether 110 includes only the connecting strap 111, the connecting strap 111 may not form the third loop 1113. In addition, the connecting strap 111 may pass through the adjuster 113 before the stitching process, and then be stitched to form the closed third loop 1113. Alternatively, the adjuster 113 may be a structure with a closable aperture, that is, the closed third loop 1113 first is formed by the stitching process, then the adjuster 113 is connected to the third loop 1113 through its opened aperture, and the aperture is closed after connection.

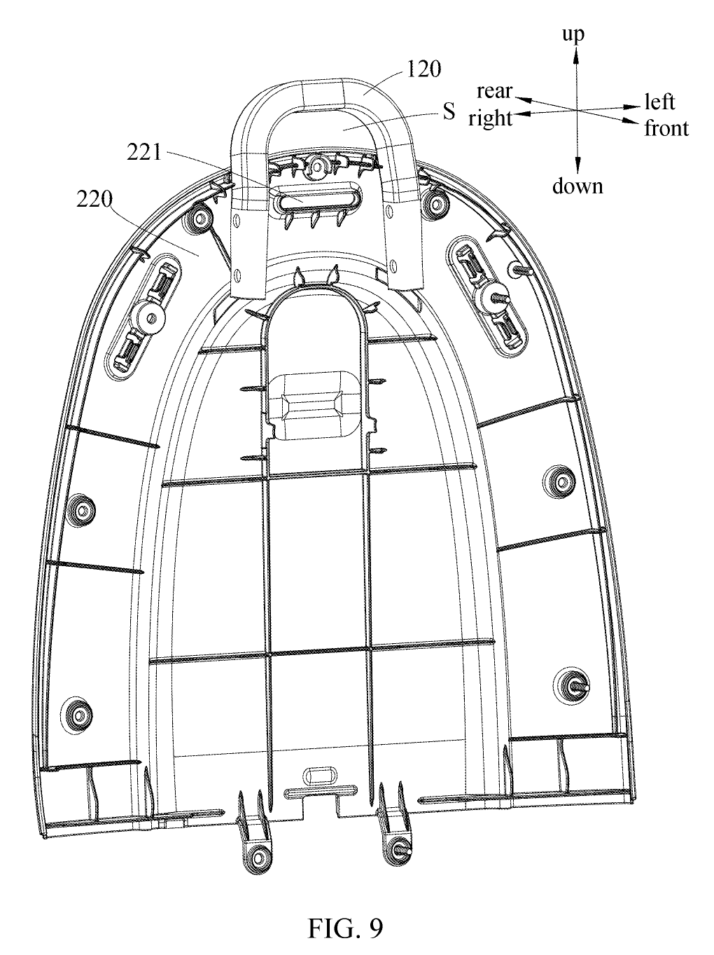

As shown in FIGS. 9 to 14, during assembly, the first connecting rod 120 may pass through the first loop 1111, and the first connecting rod 120 may be mounted (e.g., by snap fit) to the rear cover 220 of the base 20. Then, the connecting strap 111 passes through the exit hole 221 of the rear cover 220, that is, an end of the connecting strap 111 having the second loop 1112 passes through the exit hole 221 from rear to front to reach a front side of the rear cover 220. Alternatively, this end may not be pre-stitched, but instead the closed second loop 1112 may be formed by stitching after the end passes through the rear cover 220. In this way, a size of the exit hole 221 only needs to consider thickness and width of the connecting strap 111 itself, without need to consider an increase in the thickness resulting from stitching the second loop 1112 or even an increased size caused by the second loop 1112 incorporating additional members (such as members used for connection the connecting rods). Alternatively, one end having the second loop 1112 may first pass through the exit hole 221 and reach the front side of the rear cover 220, and then the first connecting rod 120 may pass through the first loop 1111 and be mounted to the rear cover 220 of the base 20. That is, the present disclosure does not specifically limit the sequence between the passage of the connecting strap 111 through the rear cover 220 and the passage of the first connecting rod 120 through the first loop 1111.

Subsequently, the two ends of the inverted U-shaped first connecting rod 120 are inserted into the ends of the two positioning rods 140, in which the positioning rods 140 are fixed to the base body 210 of the base 20, so that the rear cover 220 of the base 20 is mounted to the base body 210. However, it can be understood that the rear cover 220 and the base body 210 are not tightly fitted together at this stage, and there is a mounting gap between the two to allow the second connecting rod 130 to simultaneously pass through the first connecting holes 141 of the positioning rods 140 and the first holes 121 of the first connecting rod 120, thereby connecting the first connecting rod 120 to the two positioning rods 140.

It can be understood that in a case where the first connecting rod 120 is in the inverted U-shape, the first loop 1111 may be located in a middle position of the horizontal segment of the inverted U-shape, and the second loop 1112 may be suspended between the two vertical segments of the inverted U-shape. Thus, after the two ends of the first connecting rod 120 are inserted into the ends of the two positioning rods 140, during insertion of the second connecting rod 130, the second connecting rod 130 first passes through the first connecting hole 141 and the first hole 121 on one side, then passes through the second loop 1112, and afterwards passes through the first connecting hole 141 and the first hole 121 on the other side, so that the second connecting rod 130 not only realizes connection between the first connecting rod 120 and the two positioning rods 140, but also passes through the second loop 1112.

In addition, the above mounting gap also allows the guide rod 150 to simultaneously pass through the second connecting holes 142 of the positioning rods 140 and the second holes 122 of the first connecting rod 120, in order to connect the first connecting rod 120 with the two positioning rods 140. The second connecting holes 142 are located above the first connecting holes 141, and the second holes 122 are located above the first holes 121, so that the guide rod 150 may be located above the second connecting rod 130. In addition, during insertion of the guide rod 150 into the positioning rods 140 and the first connecting rod 120, the guide rod 150 may contact the connecting strap 111 at the rear side of the connecting strap 111. Therefore, the guide rod 150 may play a guiding role in the routing of the connecting strap 111 in the up-down direction and the front-rear direction.

In addition, as shown in FIGS. 6 and 14, the end of the second connecting rod 130 extends out of the positioning rod 140 on the other side, and the end of the guide rod 150 extends out of the positioning rod 140 on the other side. As shown in FIG. 12, the end of the second connecting rod 130 has a fixing hole 131, and the end of the guide rod 150 has a fastening hole 151; after the second connecting rod 130 and the guide rod 150 pass through the positioning rods 140 and the first connecting rod 120, the connection among the second connecting rod 130, the positioning rods 140, and the first connecting rod 120 may be secured by a fixing member 160 of the tether assembly 10 passing through the fixing hole 131 of the second connecting rod 130, and the connection among the guide rod 150, the positioning rods 140, and the first connecting rod 120 may be secured by another fixing member 160 of the tether assembly 10 passing through the fastening hole 151 of the guide rod 150. Optionally, the fixing members 160 may be fixing clips as shown in FIG. 12, such as an “S-shaped clip” or a “spring clip”, to retain the positions of the second connecting rod 130 and the guide rod 150 and prevent them from moving; meanwhile, such fixtures allow for quick installation and detachment. However, the present disclosure is not limited thereto.

It can be understood that the fixing hole 131 may be provided only at one end of the second connecting rod 130, while the other end of the second connecting rod 130 is designed to have a size larger than a diameter of the first connecting hole 141 of the positioning rod 140 (as shown in FIGS. 6 and 14), to prevent the other end of the second connecting rod 130 from entering the first connecting hole 141. The fixing hole 131 may also be provided at each of two ends of the second connecting rod 130, so that the two ends of the second connecting rod 130 may be prevented from displacement by cooperation of the fixing member 160 and the fixing hole 131. Similarly, the fastening hole 151 may be provided at one or two ends of the guide rod 150, which will not be elaborated here.

Finally, the rear cover 220 may also be secured to the base body 210 (e.g., by screws) to complete the assembly of the tether assembly 10. The above assembly process is simple and convenient, and several components of the tether assembly 10 may be multifunctional, improving the structural functionality and compactness of the tether assembly 10.

When the tether assembly 10 is assembled to the seat body 30, the assembly method is the same as the above assembly method, and only needs to replace the base body 210 of the base 20 with the main body of the backrest 310 of the seat body 30, and the rear cover 220 of the base 20 with the rear cover of the backrest 310, which will not be elaborated here.

As described above, the connecting strap 111 of the tether assembly 10 according to the present disclosure is simultaneously fitted over the first connecting rod 120 located above the top of the base 20 and the second connecting rod 130 located inside the base 20, which may not only enhance the stability of the connecting strap 111 and the base 20, but also increase the height of the connection position of the connecting strap 111, allowing the tether assembly 10 to be connected to the vehicle at a higher position, thereby mounting the safety seat 1 including the tether assembly 10 on the vehicle more stably and reducing the risk of the safety seat 1 tipping forwards during sudden braking or even collision.

After considering and practicing the contents disclosed in the specification, other embodiments of the present disclosure are readily conceivable for those skilled in the art. The present disclosure is intended to cover any variations, uses, or adaptive changes of the present disclosure, which follow the general principles of the present disclosure and include common knowledge or conventional technical means in the art that are not disclosed in the present disclosure. The specification and embodiments are only considered exemplary, and the true scope of the present disclosure is indicated by claims of the present disclosure.

Although the present disclosure has been described with reference to typical embodiments, terms used herein are illustrative and exemplary rather than restrictive. Since the present disclosure may be implemented in various forms without departing from the essence and principles of the present disclosure, it should be understood that the above embodiments are not limited to any of the aforementioned details, but should be interpreted as broadly as possible within the scope defined by the claims. Therefore, all changes falling within the scope of the claims or their equivalent should be covered by the claims.

### Reference numerals

1 safety seat

10 tether assembly

110 tether

111 connecting strap

1111 first loop

1112 second loop

1113 third loop

1114 connection part

112 adjusting strap

1121 adjusting end

1122 connecting end

1123 connector

113 adjuster

1131 fixed end

1132 operating end

1133 adjusting knob

120 first connecting rod

121 first hole

122 second hole

130 second connecting rod

131 fixing hole

140 positioning rod

141 first connecting hole

142 second connecting hole

150 guide rod

151 fastening hole

160 fixing member

20 base

210 base body

220 rear cover

221 exit hole

230 first limiting hook

240 vertical portion

250 horizontal portion

30 seat body

310 backrest

320 second limiting hook

S winding space

What is claimed is:

1. A tether assembly for connecting a base of a safety seat to a vehicle, the tether assembly comprising:
a first connecting rod, a second connecting rod, and a tether;
wherein the first connecting rod is at least partially disposed above a top of the base, and the second connecting rod is disposed inside the base;
the tether is connected to the second connecting rod and a part of the first connecting rod located above the top of the base, and is detachably connected to the vehicle.

2. The tether assembly according to claim 1, wherein the tether comprises a connecting strap connected to the first connecting rod and the second connecting rod, the connecting strap forms a first loop and a second loop by winding at connection positions with the first connecting rod and the second connecting rod, respectively, and the first connecting rod passes through the first loop and the second connecting rod passes through the second loop.

3. The tether assembly according to claim 1, wherein the first connecting rod is connected to the second connecting rod.

4. The tether assembly according to claim 2, further comprising a positioning rod that is disposed inside the base together with the second connecting rod;
wherein the first connecting rod and the positioning rod are interconnected along a first direction, and the second connecting rod is connected, along a second direction intersecting with the first direction, to the first connecting rod and the positioning rod that are interconnected.

5. The tether assembly according to claim 2, wherein the base is provided with an exit hole, to allow the tether to extend between the first loop located above the top of the base and the second loop located inside the base.

6. The tether assembly according to claim 5, further comprising a guide rod that is disposed inside the base together with the second connecting rod;
wherein the guide rod is in contact with a part of the connecting strap located between the first loop and the second loop, to guide a routing direction of the connecting strap between the first loop and the second loop.

7. The tether assembly according to claim 2, wherein the tether further comprises an adjuster and an adjusting strap, the adjusting strap is connected to the connecting strap through the adjuster and is detachably connected to the vehicle, and the adjuster is configured to lock or unlock a length of the adjusting strap between the adjuster and the vehicle; and
a part of the connecting strap located between the first loop and the second loop form a third loop by winding, and the third loop is fitted over the adjuster.

8. The tether assembly according to claim 7, wherein a winding space is formed between the top of the base and a part of the first connecting rod located above the top of the base, and the part of the connecting strap located between the first loop and the second loop passes through the winding space and forms the third loop by winding.

9. The tether assembly according to claim 7, wherein:
the connecting strap is provided with a connection part, and the connecting strap is closed by the connection part to form the first loop and the third loop;
the first loop and the third loop are located on two opposite sides of the connection part; and
a winding direction of the connecting strap at the first loop is opposite to a winding direction of the connecting strap at the third loop.

10. The tether assembly according to claim 6, wherein the guide rod is located on a front side of the exit hole, to guide the tether to extend rearwards from the front side of the guide rod to the exit hole.

11. A safety seat comprising:
a base, a seat body, and a tether assembly;
wherein the tether assembly is configured to connect the base to a vehicle, and comprises a first connecting rod, a second connecting rod, and a tether, wherein the first connecting rod is at least partially disposed above a top of the base, and the second connecting rod is disposed inside the base;
the tether is connected to the second connecting rod and a part of the first connecting rod located above the top of the base, and is detachably connected to the vehicle;
wherein the seat body is rotatably connected to the base and has a forward-facing use state and a rearward-facing use state relative to the base, and the tether assembly is configured to be disposed between the base and the vehicle.

12. The safety seat according to claim 11, wherein the tether comprises a connecting strap connected to the first connecting rod and the second connecting rod, the connecting strap forms a first loop and a second loop by winding at connection positions with the first connecting rod and the second connecting rod, respectively, and the first connecting rod passes through the first loop and the second connecting rod passes through the second loop.

13. The safety seat according to claim 11, wherein the first connecting rod is connected to the second connecting rod.

14. The safety seat according to claim 12, further comprising a positioning rod that is disposed inside the base together with the second connecting rod;
wherein the first connecting rod and the positioning rod are interconnected along a first direction, and the second connecting rod is connected, along a second direction intersecting with the first direction, to the first connecting rod and the positioning rod that are interconnected.

15. The safety seat according to claim 12, wherein the base is provided with an exit hole, to allow the tether to extend between the first loop located above the top of the base and the second loop located inside the base.

16. The safety seat according to claim 15, further comprising a guide rod that is disposed inside the base together with the second connecting rod;
wherein the guide rod is in contact with a part of the connecting strap located between the first loop and the second loop, to guide a routing direction of the connecting strap between the first loop and the second loop.

17. The safety seat according to claim 12, wherein the tether further comprises an adjuster and an adjusting strap, the adjusting strap is connected to the connecting strap through the adjuster and is detachably connected to the vehicle, and the adjuster is configured to lock or unlock a length of the adjusting strap between the adjuster and the vehicle; and
a part of the connecting strap located between the first loop and the second loop form a third loop by winding, and the third loop is fitted over the adjuster.

18. The safety seat according to claim 17, wherein a winding space is formed between the top of the base and a part of the first connecting rod located above the top of the base, and the part of the connecting strap located between the first loop and the second loop passes through the winding space and forms the third loop by winding.

19. The safety seat according to claim 17, wherein:
the connecting strap is provided with a connection part, and the connecting strap is closed by the connection part to form the first loop and the third loop; and
the first loop and the third loop are located on two opposite sides of the connection part, and a winding direction of the connecting strap at the first loop is opposite to a winding direction of the connecting strap at the third loop.

20. A tether assembly for connecting a seat body of a safety seat to a vehicle, the tether assembly comprising:
a first connecting rod, a second connecting rod, and a tether;
wherein the first connecting rod is at least partially disposed above a top of the seat body, and the second connecting rod is disposed inside the seat body; and
the tether is connected to the second connecting rod and a part of the first connecting rod located above the top of the seat body, and is detachably connected to the vehicle.
